(19) United States
(12) Patent Application Publication
(10) Pub. No.: US 2022/0013097 A1
(43) Pub. Date: Jan. 13, 2022

(54) METHOD, SYSTEM AND COMPUTER PROGRAM FOR ENABLING FLEXIBLE SOUND COMPOSITION UTILITIES

(71) Applicant: Scratchvox Inc., Toronto (CA)

(72) Inventor: Scott Barkley, Toronto (CA)

(73) Assignee: Scratchvox Inc., Toronto (CA)

(21) Appl. No.: 17/371,190

(22) Filed: Jul. 9, 2021

Related U.S. Application Data
(60) Provisional application No. 63/050,404, filed on Jul. 10, 2020.

(51) Int. Cl. G10H 1/00; G10H 1/053; G10H 1/46

(52) U.S. Cl. CPC G10H 1/0008; G10H 1/053; G10H 1/46; G10H 2210/105; G10H 2220/116; G10H 2220/126; G10H 2220/096; G10H 2210/325

(57) ABSTRACT

A computer system for enabling generation/controlling/modification of sound elements is provided. A computer program defines a sound engine. The sound engine includes or is linked to one or more musical composition interfaces that enable one or more users to access a music generator/controller/modifier utility (“music generator”), so as to graphically map one or more musical notes by tracing one or more Bezier paths defined that are processable by the music generator so as to define five fundamental note qualities: Tone, pitch, volume, applied effects and duration. The music generator enables user manipulation of the Bezier paths, including touch input modification of the paths (e.g. dragging, forming etc.) that modify fundamental qualities of the corresponding note.

### CROSS REFERENCE TO RELATED APPLICATIONS

This application claims all benefit, including priority, of U.S. Provisional Patent Application Ser. No. 63/050,404, filed Jul. 10, 2020.

### BACKGROUND OF THE INVENTION

### 1. Field of the Invention

The present invention relates to computer systems for creating, modifying and generating sound. The present further relates to computer system implemented musical composition tools.

### 2. Prior Art

Musical composition applications generally employ direct numeric value modifications (i.e. a MIDI “event list”), separate modifiable linear representations to define note characteristics, or simple rectangular bars to designate a pitch center over time against a pre-set grid, but with accompanying pitch modulation information displayed separately. Typically, a linear bar representation of a fixed note pitch and its duration, (FIG. 1, A) and another linear representation for pitch bend variables as related to the fixed pitch (FIG. 1, B) and still another to show relative volume levels (FIG. 2). Still another representation will show various pre-set applications of a filter effect such as a flange (FIG. 3). While this method provides a degree of control over note characteristics it has a number of limitations.

Prior musical composition applications generally manipulate recorded, continuous sounds, whose basic pitch and volume properties are fixed. In prior art applications, pitch/volume/effect can be roughly input and shifted overall as a whole, but the more complex a change, the greater the difficulty in enabling the manipulation of the sounds to reflect desired changes.

With some prior art musical composition applications, sounds are represented visually by a complex audio description of all the tones and overtones (FIG. 4). The user can see that a sound sample is displayed, but may have no idea of its pitch, precise volume or applied effect by simply looking at it. This creates restrictions in the ability of users to easily tune sound parameters. A musical composition includes numerous sounds, which compounds the problem.

Prior art musical composition utilities generally provide limited ability to manipulate musical content. There is a need for a system and method that provides musical composition functionality that is more flexible and responsive to users.

There is a further need for musical composition systems and methods that work well with touch interface computers and their wireless styluses.

Prior art linear visual presentations of a note's pitch variations and duration are not intuitive as they are managed by two different interfaces that function independently of each other (FIG. 1 A, B). Linear representations of pitch bend in prior art solutions are flat lines, moving abruptly from one value to the next. Or, should the extra care be taken, a line is typically drawn from one percentage point to percentage to the next, and any in-between values are inferred from these straight lines (FIG. 1, C). This does smooth things out somewhat, but either case tends to produce abrupt pitch changes at those points, which (as shown in FIG. 1, C) do not accurately reflect the fluid pitch transitions of many instruments like the violin.

Additionally, prior art linear representations of pitch typically display an arbitrary means of representation above or below the set pitch, typically a value in MIDI pitch bend (0->16383) or a percentage of maximum possible variation (FIG. 1, C). This is counter-intuitive, as percentages displayed don't inform the user what the bent pitch is in relation to the musical scale, only the degree of deviation from the fixed pitch.

Even if extra care is taken to provide linear paths between key volume points, as shown in FIG. 2 this too can produce abrupt volume changes at the transition points (FIG. 2, A), which do not accurately reflect the fluid volume transitions of many instruments like the violin.

For applying a filter effect, simple pixel-based curves allow for some choices for the application of an effect, but can't be configured for any complex application of a chosen effect (FIG. 3).

Also, a number of prior art musical “drawing” computer programs are known. These generally enable a user to drag a finger or stylus across a touch screen to produce notes. On such program is SoundBrush™ (see FIG. 5 for an example of this method). In these prior art computer programs, note drawing happens by assigning a specific pitch to a specific pixel or group of pixels on the touch screen (the “View”). This provides limited entertaining functionality but does not constitute a real musical utility for a number of reasons.

First, pitch-to-pixel mapping technology typically results in pitch stepping as activation leaps abruptly from pixel to pixel (FIG. 5).

Second, pitch-to-pixel pitch mapping is generally either crude or impossible for making later adjustments to a drawn note, as the user is limited to ‘pixel on’ and ‘pixel off’ options, and paths—once drawn typically lose their identity as a single, cohesive path. Even if these issues are addressed, prior art solutions are still limited in their ability to smoothly represent pitch or volume transitions, as any manipulated paths would still be subject to the stepping inherent in pitch-to-pixel relationships.

Also, most musical “drawing” programs only allow the user to input variations in pitch, as the volume is pre-set to a uniform level. This ignores a key component of music; the variations of volume within a note or group of notes.

Also, these “drawing” programs do not allow for the application of a chosen filter effect.

Therefore there is a need for an improved system for creating, modifying and generating musical notes that improves on at least one of these aspects. There is a further need for an improved musical composition application that improves on at least one of these aspects. This is especially true in recent years given the wide spread acceptance of touch interface computers.

### SUMMARY OF THE INVENTION

In one aspect there is a system for generating, controlling, modifying and applying filter effects of sound elements, comprising:

(a) One or more computers, and a

(b) Sound generating/controlling/modification/effect utility (“sound processing utility”) linked to the one or more computers, or accessible by the one or more computers, the sound processing utility presenting, or initiating the presentation, on a display connected to the one or more computers, of one or more music composition/modification graphical user interfaces (“interface”) that enable one or more users of the system to graphically map on the interface one or more musical elements as parametric representation thereof, wherein the parametric representations are encoded with information elements corresponding to the musical elements, wherein the parametric representations, and the encoded information elements, can both be defined or modified by the user in the interface in a flexible manner so as to enable the users(s) to generate, control, modify or apply an effect to sound entities that achieve a broad range of musical possibilities, in an easy to use and responsive manner.

In another aspect, there is provided a system, wherein the parametric representations consists of parametric curves that define a path of curves.

In another aspect, there is provided a system, wherein the musical elements consist of pitch, volume, duration and effects application of notes.

In another aspect this is provided a system further comprising one or more audio processing components operable to play the sound entities.

In another aspect, there is provided a system, wherein the parametric representations encapsulate the information for displaying a path on the interface, and also encapsulate the information for playing the sound entities, and wherein the parametric representations are modifiable based on user input to the interface such that modifications to the parametric representations make the corresponding changes to the information for playing the sound entities.

In another aspect, there is provided a system, wherein the parametric representations are generated using one or more processes that create scalable parametric paths, such that the encoding of the parametric representations with the information elements is scalable, thereby providing flexible and responsive system characteristics.

In another aspect, there is provided a system, wherein the parametric representations are generated using Bezier paths.

In another aspect, there is provided a system, wherein the sound processing utility creates calculation points for a parametric representation corresponding to the musical elements into a Bezier path, stores the path, and if input is received from the interface to modify the parametric representation, more calculation points are added to the Bezier path corresponding to such input, thereby enabling the modification of the sound entities such that smooth transitions are audible when the sound entities are played using an audio processing component.

In another aspect, there is provided a music composition tool incorporating the sound processing utility as previously described.

In another aspect, there is provided a system wherein the interface includes one or more grids, each grid including a timeline that is synced to the other grids, and permitting the user to create parametric representations and placing them in the timeline so as to construct a musical composition.

In another aspect, there is provided a system wherein the one or more grids include a pitch grid (FIG. 6), wherein the pitch grid is executable to allow one or more users to draw on the pitch grid one or more paths corresponding to a note and any pitch between any notes so as to create a spatial representation of pitch attributes of sound elements that correspond to an associated pitch frequency spectrum, and the pitch grid either vertically or horizontally is a spatially accurate representation of the frequencies of a musical scale, such that the space between half notes such as ‘mi’ and ‘fa’ is half the distance between whole notes such as ‘do’ and ‘re’.

In another aspect, there is provided a system, wherein the one or more grids further include a volume manipulation grid (FIG. 7) wherein either from side-to-side of the grid or top-to-bottom of the grid equals the range of volume, from silent to loudest, that is synchronized with the pitch grid such that input to the pitch grid and the volume grid in aggregate enables modulation of the musical elements with a range of musical possibilities,

In another aspect, there is provided a system, wherein the one or more grids further include an effects grid(s) (FIG. 8) wherein either from side-to-side of the grid or top-to-bottom of the grid equals the degree of application of an effect, that is synchronized with the pitch and volume grids such that input to the pitch grid, volume grid and the effects grid in aggregate enables modulation of the musical elements with a range of musical possibilities.

In another aspect, there is provided a system, wherein three vectors are assigned to an electronic stylus attached via cable or wirelessly to the touch-based computer (FIG. 9), the three vectors being stylus point of contact on the interface (FIG. 9, A), pressure of the stylus on the interface (FIG. 9, B) and angle of the stylus in relation to the plane of the interface (FIG. 9, C), with the three vectors linked to pitch input (FIG. 9, A), volume input (FIG. 9, B) and effects input (FIG. 9, C).

In another aspect, there is provided a system, wherein the physical variations by the user of these three vectors can simultaneously input Bezier paths (FIG. 10) on their respective grids (FIGS. 6, 7, 8), either by moving the stylus along the synced timeline, or by the scrolling of the grids and their timeline past a stationary stylus (FIG. 11).

It is to be understood that stylus pressure could also be set to define degree of effect and stylus angle could be set to define volume.

It is important to note that all note pitch/volume/effect paths described can also be drawn with a mouse on a non-touch screen.

In another aspect, there is provided a computer implanted method for generating, controlling, or modifying sound elements comprising:

(a) Displaying one or more music composition/modification graphical user interfaces (“interface”) implemented to one or more computers including or being linked to a touch screen display;

(b) Receiving one or more selections relevant to one or more musical elements using the interface;

(c) Generating one or more parametric paths corresponding to the selections and encoding the musical elements; and

(d) Storing the parametric paths so as to define one or more executable sound entities, wherein the sound entities can be defined or modified using the interface in a flexible manner so as to enable the generation, control, or modification of the sound entities so as to achieve a broad range of musical possibilities.

In another aspect, there is provided a method, wherein the interface includes one or more grids, a first grid for selecting pitch attributes, a second grid for selecting volume attributes, and a third or more grids for selecting effect; comprising:

(a) Accessing, including iteratively, the first grid, the second grid and the tertiary grids so as to define or modify pitch attributes, volume attributes and effect attributes for one or more sound entities;

(b) Receiving input using the interface that the definition or modification of the pitch attributes, the volume attributes and effect attributes have been completed; and

(c) Storing of one or more sound entities defined by the selection of the pitch attributes, volume attributes and effect attributes to a data store, thereby providing one or more executable sound entities based on such pitch attributes, volume attributes and effect attributes.

In this respect, before explaining at least one embodiment of the invention in detail, it is to be understood that the invention is not limited in its application to the details of construction and to the arrangements of the components set forth in the following description of illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIGS. 1 and 2 show linear representations of pitch, pitch bend, note duration and volume used in pre-existing musical creation computer programs.

FIG. 3 shows an example of current linear representations for the application of audio filter effects.

FIG. 4 shows a typical example of analogue representation of musical notes.

FIG. 5 shows example of pitch-to-pixel relationship used pre-existing music “drawing” computer programs.

FIGS. 6, 7 and 8 are examples of the new music notation system of the present invention that uses Bezier paths to denote pitch, volume, applied effects and duration.

FIG. 9 shows the 3 vectors of an electronic stylus that can be used to input Bezier paths on the music notation system of FIGS. 6, 7 and 8.

FIG. 10 shows how the 3 vectors of an electronic stylus that can simultaneously input Bezier paths on the music notation system of FIGS. 6, 7 and 8.

FIG. 11 shows a variation of FIG. 10 where the electronic stylus is constrained vertically and inputs onto the music notation system as it scrolls right-to-left.

FIG. 12 shows how pixelated paths drawn on the UI of the present invention are translated into underlying Bezier paths via a form of Model View Controller.

FIG. 13 shows a method that the present invention uses to modify the Bezier paths.

FIG. 14 is a system diagram illustrating one implementation of the computer system of the present invention, in a client computer implementation of the present invention;

FIG. 15 is a system diagram illustrating another implementation of the computer system of the of the present invention, in a client/server computer implementation of the present invention;

FIG. 16 shows a method that the present invention can use generate pitch from a model Bezier path;

FIGS. 17-37 are examples of various rules that can govern the selection and reading (playing) of pitch, volume and filter effects paths within the new music notation system of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENTS

In one aspect of the invention, a computer system, computer implemented method and computer program is provided that enables composition of musical content in a new and innovative way.

In one aspect of the invention, the computer system and computer implemented method of the present invention provides a novel and innovative mechanism for: (A) generating notes, (B) controlling notes, and (C) modifying notes, as described below.

In one aspect of the invention, the computer system includes at least one computer, the computer linked to a touch input device, the computer including or being linked to an application or an application repository that provides a sound engine; the sound engine when executed (A) presents one or more musical composition interfaces or screens including or being linked to one or more musical composition interfaces, that enable one or more users to access (B) a music generator/controller/modifier utility (“music generator”), so as to graphically map one or more musical notes by tracing one or more paths defined by Bezier paths and then processable by the music generator so as to define generally pitch, volume, duration and applied effects of notes.

The system and method is designed to be very easy for learners use. The system and method of the present invention provides for the first time a new and more intuitive form of music notation where “the eye meets the ear”.

In one aspect of the invention, a new system and method if provided for storing and playing musical notes. In one aspect, a musical note is defined by four properties or musical information elements: (A) pitch, (B) volume (or loudness), (C) duration and (D) applied effects.

In one aspect of the present invention, these properties are captured using a touch based graphical user interface (“GUI”) presented touch screen interface. The GUI is linked to a computer program component that allows one or more users, based on touch input, to make one or more selections associated with such musical information elements, and these selections are displayed on the GUI, and these representations include, are based on or are linked to a plurality of parametric curves defining a “path” that encodes information corresponding to the musical information elements.

In another aspect of the invention, a suitable process or algorithm is used for defining these curves and paths so that the encoding of the curves/paths is scalable. In one contribution of the present invention, Bezier paths have been selected so that the paths are readily modifiable because Bezier paths are scalable indefinitely. The musical information elements, in one aspect, in effect are stored as algorithms of Bezier paths, which provides the remarkable and surprising flexibility and responsiveness of the system and method of the present invention.

In another aspect of the invention, an electronic stylus connected either via a cable or wirelessly to the touch-based computer, can be used input paths on the GUI.

One aspect of the invention is a new computer implemented method for encapsulating data that relates to a note.

In one aspect, the present invention combines the best of the previously separate pitch center “bars” and pitch modulation point and line technology, into a single mathematically calculated Bezier path object, which encapsulates or stores all necessary data to both display the path to a control user interface, and plays as the audio that it represents using a suitable music player.

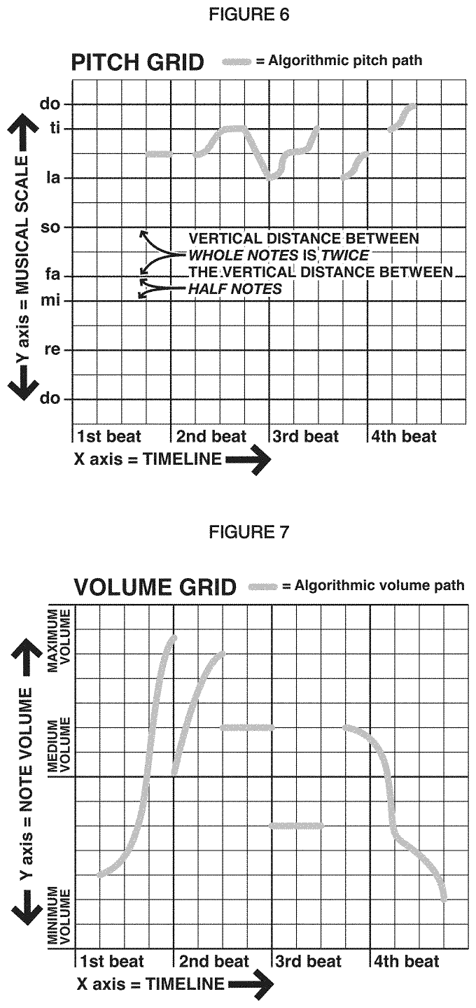

In one aspect, the present invention presents three or more easy-to-understand synced grids that accurately display volume, pitch and applied effect as shown in FIGS. 6, 7 and 8. Unlike that of most musical composition programs, the learning curve of the present invention is minimal.

This invention combines the best of the previously separate pitch center “bars” and pitch modulation point and line technology into a single mathematically calculated Bezier path object, which encapsulates or stores all necessary data to both display the path to control surface, and play to the audio it represents in the sound engine.

This invention allows the creation of music generation/control/modification applications that follow best practices in software design, by significantly improving the encapsulation of musical information into a representation of an associated musical note.

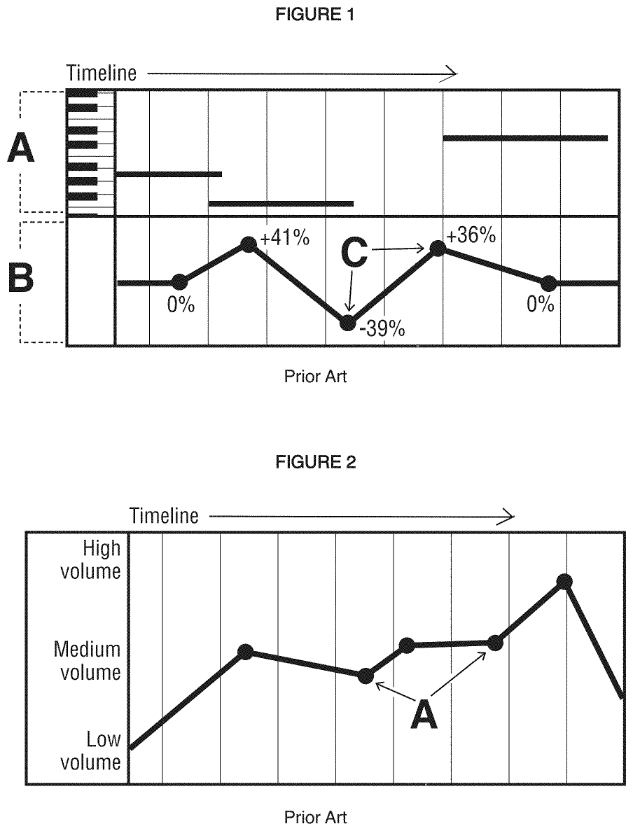

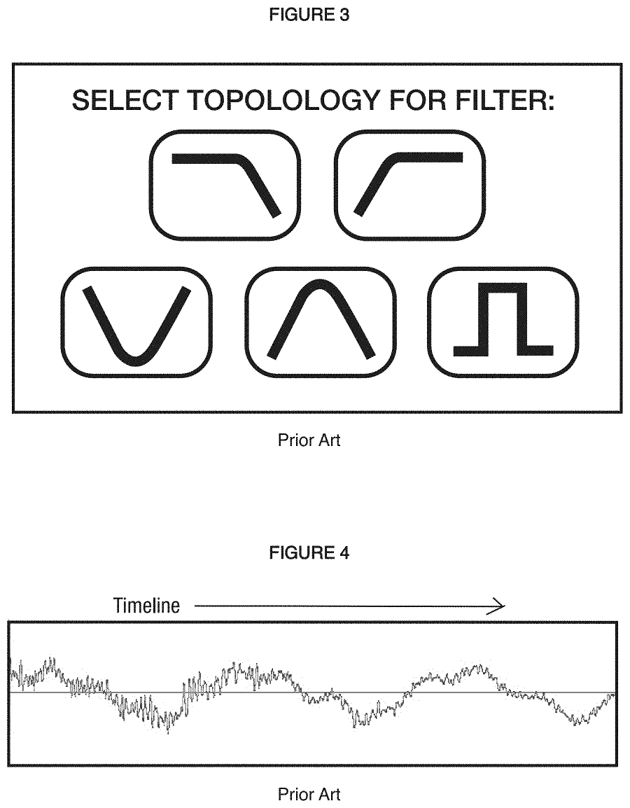

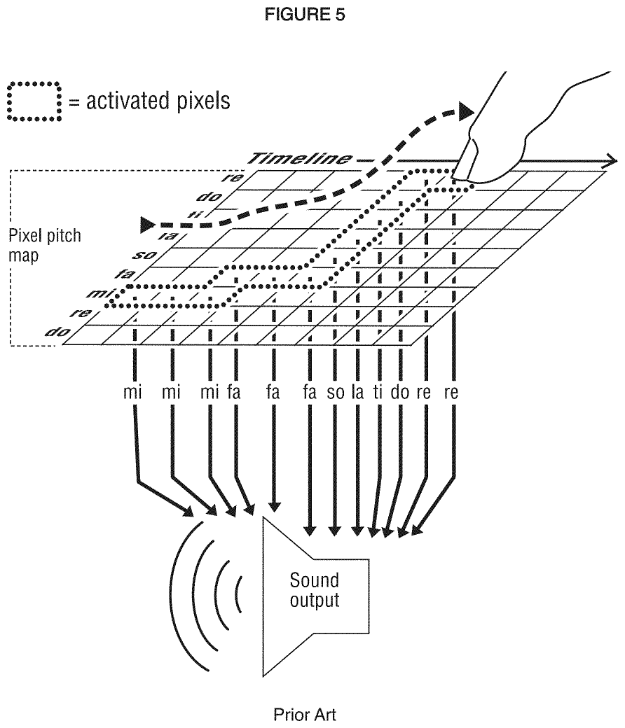

In another aspect, the system and method of the present invention takes the note pitch, pitch bend, note duration and applied effect information that is represented in most musical composition programs as loosely related data (i.e. MIDI event list), or as many separate linear or pixel based representations (FIGS. 1, 2, 3), and combines this information into a single, accurate and more intuitive Bezier path objects (FIG. 6, 7, 8). The Bezier path can be a curve having an arbitrary node count and a node type. This greatly simplifies note modification because user only needs to modify one path to modify the key note properties of note on, note off and pitch/pitch bend.

In another aspect, the system and method of the present invention adapts “Model-View-Controller” or “MVC” techniques, as shown in FIG. 12. In the present invention, this “MVC” pattern is used to calculate from that which is drawn on suitable graphical user interface (“GUI”) displayed on a touch screen (such as the screen of a mobile device, tablet computer, or touch screen of a laptop computer, or desktop computer) to create an underlying Bezier path or model object or Bezier model object (FIG. 12, A). The GUI provides a control surface or “view” that is used by users to generate/control/modify note properties.

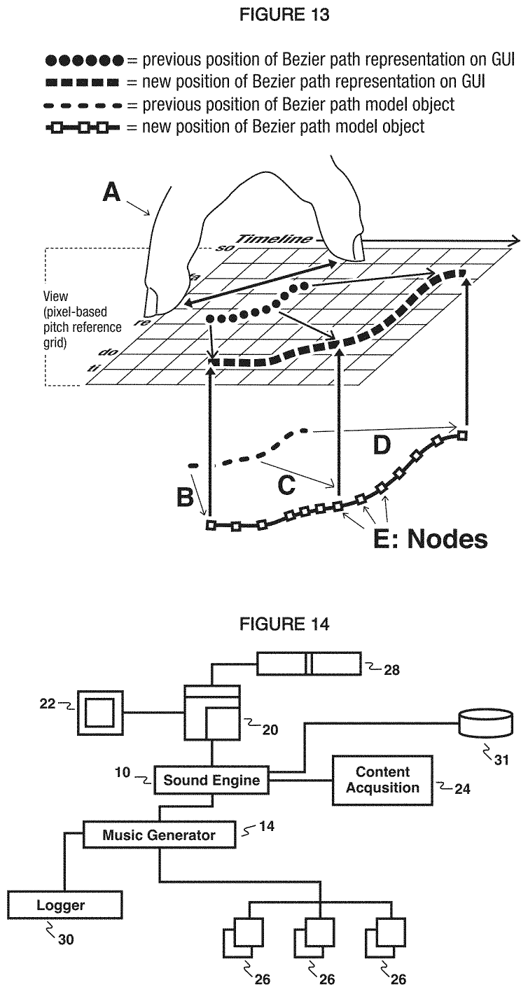

When the Bezier model object is then displayed on the control surface, what is displayed may appear to be merely the pixels that the user has drawn using their finger, a stylus or electronic stylus. But the underlying model object encapsulates or holds all data required to accurately display the path on the control surface and generate any data necessary to play the path accurately with an audio engine. The user may endlessly manipulate what is displayed (FIG. 13, A) in the view or control surface, but these manipulations are interpreted as actions on the underlying mathematical Bezier Model object (FIG. 13, B, C, D). Therefore the system and method of the present invention is implemented such that the underlying Bezier model objects have an arbitrary degree of resolution, therefore it does not “step” as the representations in prior art solutions do, and the underlying Bezier model object also never loses its identity unless erased

The mathematical descriptions of the underlying curved Bezier paths are used to calculate the pitch, volume, duration and applied effect as required anywhere along the curves of the Bezier path, to an arbitrary degree of resolution.

The system and method of the present invention generates musical notes by placing sufficient calculation points along its Bezier paths to create a smooth and pleasing sound. When its paths are stretched as in FIG. 13, A, the present invention simply adds more calculation points along the path, keeping the sound smooth and pleasing. This is possible because a Bezier path's algorithms allow it to be infinitely enlarged, downsized, inverted, flipped etc., and adjusted via the repositioning of nodes (FIG. 13, E). The Bezier paths and therefore the musical notes of the present invention can be endlessly modified and yet have the surprising result of maintaining not only an accurate pitch, volume, duration and effect description but also maintaining audio fidelity. The present invention's musical notes are therefore resolution independent.

The present invention is therefore not dependent on direct pitch-to-pixel relationships, as represented in the view, to generate notes. This results in smooth and pleasing notes that imitate the fluid pitch, volume and effect transitions of musical instruments such as the trombone. The sophisticated use of the Model View Controller patterns to generate mathematical Bezier “model” objects overcomes the ‘stepped’ pitch effect created by direct pitch-to-pixel dependency in prior art musical “drawing” programs.

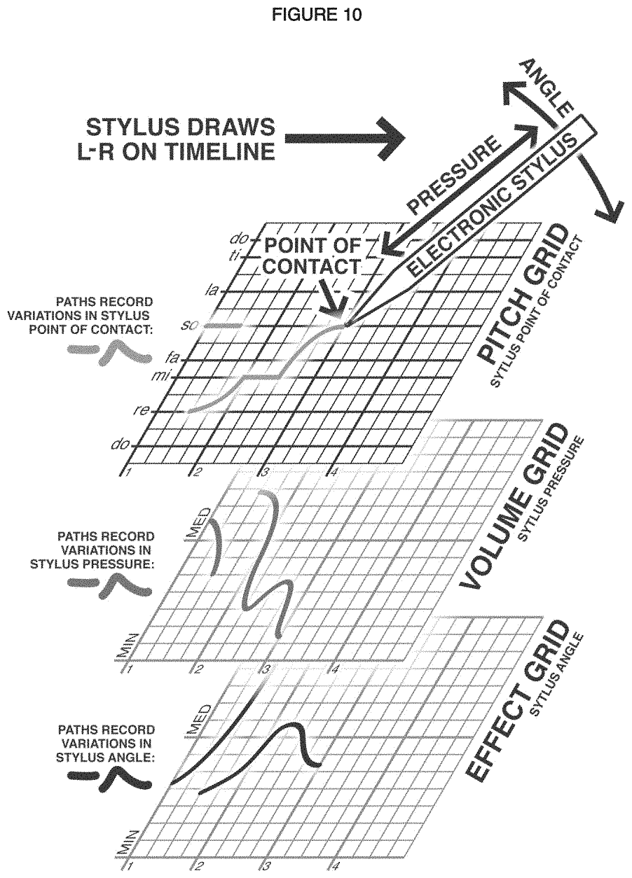

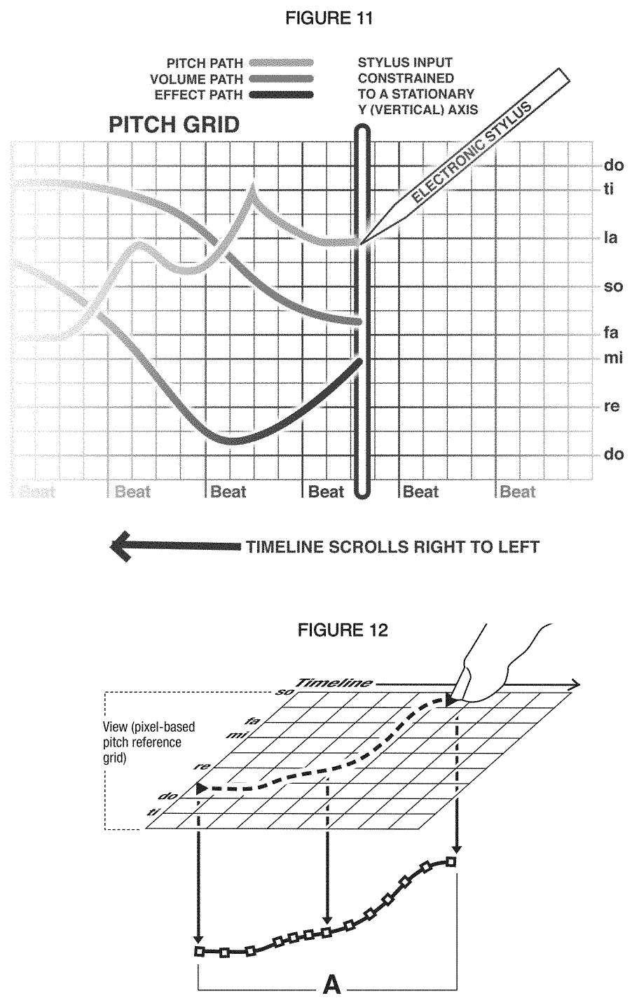

The system and method of the present invention displays the underlying Bezier paths as accurate views of pitch, volume and effects on their synced grids, as shown in FIG. 10. In a pitch grid view, pitch accuracy is achieved by having the pitch grid view display every semitone of the 12-tone musical scale. Thus a user can draw on the pitch grid a path that describes any note and any pitch in between notes in an intuitive manner as the path grid is a spatially accurate representation of the pitch frequency spectrum (FIG. 6). This overcomes the confusing display of pitch bend as an arbitrary numerical or percentage of deviation above/below a fixed pitch that's employed by most prior art musical composition programs including the representative program depicted in FIG. 1.

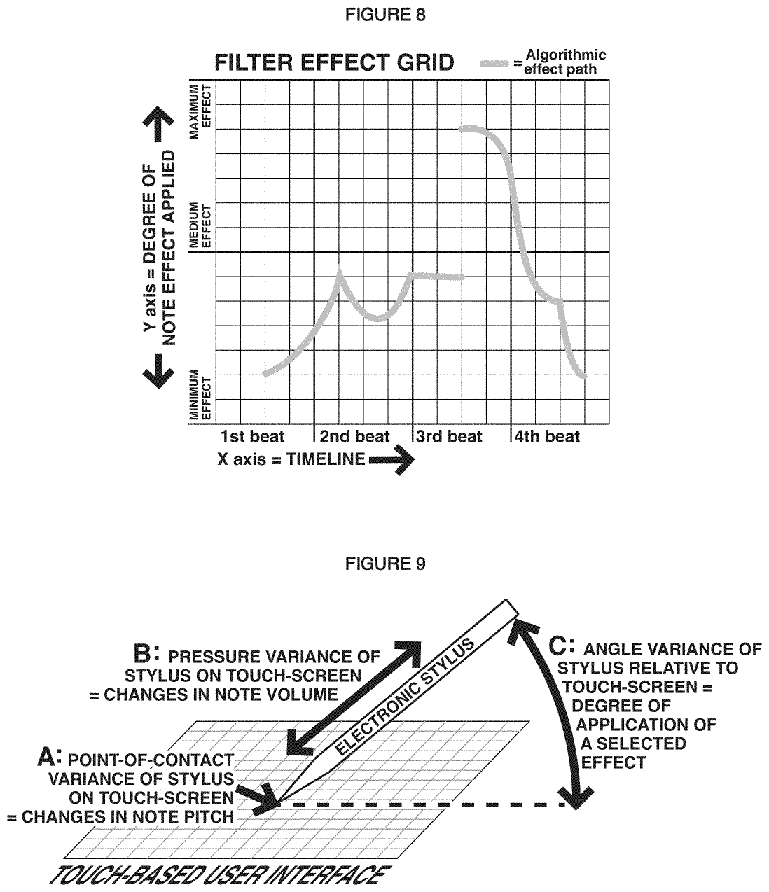

As shown in FIGS. 6, 7, 8, in one aspect of the invention, may use three or more time-aligned grids. The first grid is a visually accurate representation of pitch frequency where a whole tone, semi tone or any pitch in between can be represented by a simple yet malleable path drawn along the shared timeline (FIG. 6). The second grid is a visually accurate representation of note volume range, showing highest to low (no) volume. Volume can be represented by a simple yet malleable path drawn along the shared timeline (FIG. 7). The third or more grids is a visually accurate representation of degree of application of an effect. Degree of application of an effect can be represented by a simple yet malleable path drawn along the shared timeline (FIG. 8). Duration of a pitch, volume description or an applied effect is simply the length of the paths along the timeline. Thus the present invention negates the need to learn conventional music notation.

As shown in FIG. 10, an electronic stylus attached to a touch-based computer via either a cable or wirelessly, can be programmed such that three of its vectors can each input into simultaneously onto the pitch grid, the volume grid and an effect grid. Stylus point of contact defines pitch on the pitch grid, stylus pressure controls volume and angle of the stylus apples degrees of an effect.

As shown in FIG. 7, the system and method of the present invention uses underlying curved Bezier paths to accurately play any volume or volume transition and therefore is not limited by the flat point-to-point volume transitions used by most musical composition programs that produce abrupt changes in volume (for example as shown in FIG. 2). This allows the present invention to accurately imitate the fluid volume transitions of instruments such as the violin.

Furthermore, as shown in FIG. 13, the system and method can include a GUI that is linked to a Model View Controller that allows a user to modify the underlying curved model Bezier paths into any description of a note's pitch, volume and applied effect through the manipulation of their pixilated representations on the GUI. This allows for example for novel note modulations effected by the stretching, rotating, copying, twisting etc. of the note's Bezier path descriptions of pitch, volume and effect, as shown in FIG. 13, thereby permitting highly flexible user interaction with musical content.

### Implementation.

The functionality described may be implemented as a number of different computer systems and computer implemented methods. For example, the music generator of the present invention may be implemented as computer program implemented to a mobile device, a tablet computer, laptop computer or desktop computer. The music generator may also be implemented as an Internet service, for example a cloud networking implemented online service. Further details of possible example implementations of the present invention are provided below.

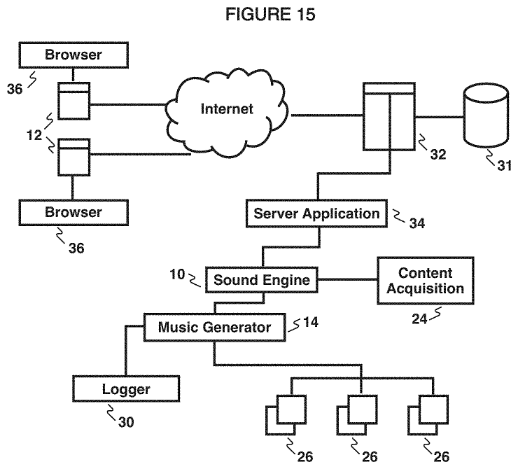

In one aspect, the present invention may be implemented by configuring a computer program that when executed by one or more computer processors provides a novel and innovative sound engine (10, FIGS. 14 and 15). FIG. 14 shows a possible client implementation of the present invention, and FIG. 15 shows a possible client/server or computer network based implementation of the present invention.

The sound engine (10) includes one or more musical composition interfaces that enable unprecedented flexibility in defining musical parameters for example for composing a song. The sound engine (10) may be implemented to or made available to any manner of computer device (20). The computer device is linked to a touch display (22).

More particularly, the sound engine (10) relies on and incorporates a novel and innovative music generator/controller/modifier (14) or “music generator”. The music generator/controller/modifier (14), which may be implemented as a musical note builder component. The music generator/controller/modifier component (14) embodies a new method of the invention for generating a musical note, as described in this disclosure. Significantly, the musical note generator/controller/modifier component (14) embodies a method for controlling a note, for example using the musical composition interfaces (12) described below. The musical composition interfaces (12) in one aspect of the invention include the music notation graphical user interfaces of the present invention, also referred to as a “music mapping GUI” of the present invention.

The music generator (14) may also be used to modify existing musical content, for example as provided by the content acquisition component (24).

A logger (30) may be linked to the music generator (14) to track user interactions with the sound engine (10) based on the method described.

More particularly, the music generator/controller/modifier component (14) incorporates one or more computer implemented methods (implemented using suitable algorithms such as those described below) for graphically mapping one or more musical notes by using one or more music mapping GUIs for (A) displaying the notes based on Bezier paths relating to pitch, volume, applied effects and their respective duration components thereof, the vectors defining a path that corresponds to these note components (pitch, volume, effects, duration), and (B) enabling the user manipulation of the paths, for example using touch input modification of the path (e.g. dragging, forming etc.) and thereby modify pitch/volume/effect/duration components thereof.

The music generator/controller/modifier (14) enables user modification in a transparent way. The use of the music generator/controller/modifier is intuitive, and enables the creation and modification of notes, and any grouping of notes without the need for knowledge of musical notation or of the complicated workings of most musical creation programs. Furthermore, the Bezier path-based definition of notes enables the shifting of note attributes in a highly flexible way, thereby enabling unprecedented experimentation with musical elements. This allows the user to create a series of musical content components (26) or “sound entity”, which are easy to create and modify.

In one particular implementation of the invention, the music generator/controller/modifier (14) defines an area in a GUI presented on a touch screen (22) that allows a user to define, using their finger a stylus or an electronic stylus, a range of pitch, volume, effect and duration possibilities.

It should be understood that the paths referred to herein are Bezier paths that are defined by mathematical algorithms, and the sound engine (10) is operable to create musical notes using these paths.

Referring to FIGS. 6, 7, 8, three possible music mapping GUIs are illustrated, in this case the music mapping GUIs enabling the definition of paths that define pitch, volume, effect and duration attributes. A vertical axis defines a visually accurate scale of pitch, volume and filter effects parameters. A horizontal axis defines note duration on a timeline. One or more suitable Bezier path-based drawing methods or technologies are used to trace the paths described. In the case of FIGS. 6, 7, 8 the paths indicates variation of pitch, volume and effect over time.

FIG. 15 illustrates a client/server computer implementation of the present invention. The sound engine (10) may be implemented to a server application (34) which may be loaded on a server computer (32). A database (31) may be connected to the server computer (32). Multiple network-connected devices, each having a touch screen, connect to the resources of the server application (34) via the Internet using a browser (36). The server application (34) may also be implemented as an application repository.

A skilled reader understands that various other computer system architectures are possible for implementing the functionality described herein.

The sound engine (10) may include the functions and features as previously described.

In one aspect of the invention, an easy-to-use and flexible musical composition interface is provided. Possible embodiments are illustrated in FIGS. 6, 7, 8 and 21-37, and show how a user can generate/modify musical content by manipulating Bezier paths, as well as how these Bezier paths are translated by system and method of the present invention.

A possible program screen or web screen may present one or more menus that enable a user to select from different music mapping GUIs that define attributes that collectively define how a path(s) are played. In one implementation, the system can include one or more tools that enable the navigation between a plurality of Bezier paths that may define for example a song or song segment. The paths may, in one implementation, be represented as a series of sounds that are arranged in a sequence (indicating that sounds are intended to be played after one another as a single-note melody) or in parallel (indicating that sounds are intended to play at the same time or partially at the same time as a multi-note harmonies). Various other arrangements are possible.

The system and computer program of the present invention may incorporate functions and features similar to various prior art musical composition utilities, except that notes are defined, played by, and may be modified by, the Bezier path-based technology of the present invention.

A skilled reader will understand that the present invention contemplates various different types of musical composition interfaces and associated features and user workflows. One aspect of the invention is a musical composition interface of various types that can be based on or incorporate the computer implemented methods of the present invention.

In addition to pitch, volume and effect, the sound engine (10, FIGS. 14, 15) can enable the definition of beat/duration parameters, and by enabling user configurability of pitch, volume, duration and effect as described, the computer system of the present invention provides a highly flexible, highly tunable system for composing and playing music, in one implementation.

A skilled reader will understand that the present invention permits complete and fluid sound tenability, for example complete and fluid note control of instrumental sounds. It follows from this tunability and control that users can also modify existing instrumental sounds content with the same complete and fluid note control, thereby enabling users to import source files and modify these based on user's intent, without the limitations that prior art solutions set to composition and exploration by users.

The computer system of the present invention may include a musical content acquisition component (24) that is operable, for example, to acquire instrumental musical content for modification using a musical note builder component. For example the instrumental musical content acquisition component (24) may be operable to acquire musical content such as a soundtrack. The instrumental musical content acquisition component (24) may be operable to pre-process the instrumental musical content (convert to Bezier path descriptions of its pitch/volume/effect/duration), to enable processing by the system of the present invention. For example, the instrumental musical content acquisition component (24) can acquire one or more source tones from a library or other source, and the computer system of the present invention to modify the source tones, as described, and thereby create musical content from a collection of such tones.

Significantly, a Bezier path illustrated by operation of the GUIs shown in the Figures maps precisely to a musical note's pitch/volume/effect/duration. The note's pitch/volume/effect/duration may be changed by altering the path. A user may selectively modify musical notes and compositions by selectively altering the corresponding paths, as illustrated in the various Figures.

The computer system and computer implemented method of the invention provides significant malleability, thereby creating an unmatched, immersive, dynamic and exciting musical experience. Using the musical mapping GUIs of the present invention, users can for example (a) draw a note's pitch/volume/effect/duration; (b) copy a note's pitch/volume/effect/duration; (c) incrementally roughen, rotate, stretch a note's pitch/volume/effect/duration, and so on. Each of these changes to the visual paths depicted by the present invention result in modification of the sound entity represented by the paths. In this way, the musical mapping GUIs constitute an graphical overlay, where each point maps to a musical parameter. The sound engine (10) includes a logger (30) that is operable to log the musical parameter selections represented by the paths so as to enable the sound engine (10), based on these selections to modulate sound output.

The present invention includes the conception of the idea that state-of-the-art audio processing enables the creation of “live” musical tones, as opposed to modification of stored musical content. To this end, the sound engine of the present invention builds and rebuilds the musical note mapped to the note's current path positions, thereby creating a highly responsive and expressive musical environment.

Another important innovation of the present invention, is the realization that Bezier paths can be used as a user interface metaphor for control and shaping of notes, so as to enable user manipulation of musical notes within an extensive and intricately articulated range so as to enable what a skilled reader will appreciate provides an extensive musical palette for creating music compositional elements.

The present invention has the innovative and surprising result of providing a computer system, and an easy to use GUI, that enables users to bypass the physical limitations of physical musical instruments and the musicians that play them, as well of the limited flexibility that is inherent to pre-existing art musical composition computer programs.

As shown in the FIGS. referenced herein, the computer program of the present invention utilizes Bezier path notation to instantly and precisely play any combination of the basic note components—pitch, volume, effect and duration—that a user can imagine. The computer program provides unprecedented levels of music creative control in the hands of users.

It will be readily apparent to a person skilled in the art that Bezier path-based notes of the present invention have unprecedented dexterity, in that they express any intricate and fluid transition of pitch, volume and effect application, as well as the unprecedented degree of malleability of pitch, volume and effect application, thereby permitting the user to create musical notes that would otherwise be impossible to express.

In one implementation of the present invention, the horizontal lines shown in the FIG. 6 each represent a half tone, which is easy to understand as the musical scale is made up of half tones (e.g. TI to DO) and whole tones (two half tones e.g. DO to RE). A note's duration is defined by the length of its pitch path. And the curvature of pitch/volume/effect paths can precisely define pitch/volume/effect in an unprecedented exacting manner. In accordance with the present invention, there is no need for the complex and confusing use of sharps and flats used in pre-existing musical composition programs. The present invention is therefore intuitive and easy to learn.

It is important to understand that the present invention is operable to cover the complete range of frequencies audible to the human ear.

Also, the GUI provides a mechanism for various individuals to express themselves using music, who might not otherwise be able to do so because of the need to learn musical theory, and also the system and method of the present invention may be used by young and old, and individuals who have physical disabilities. The present invention enables all users to compose and play the music that they imagine.

Music composed by the user may be stored on the database (34) shown in FIG. 15, and may be shared (by export as either a proprietary or as various common sound formats e.g. ‘.wav’, .mp3′ or MIDI) or otherwise distributed in a number of ways, including for example a social networking environment linked to the server computer (32). The server application (34) can also enable collaboration between users of two or more computers, who may access one or more collaborative composition workflows enabled by the sound engine (10).

Perhaps more importantly, a skilled reader will appreciate that the musical notes created by operation of the present invention are highly responsive. The present invention allows the dynamic creation and playing of musical notes across a full range of pitches, volumes, durations and applied effects, enabling musical virtuosity beyond what is ordinarily possible using musical instruments or prior art musical composition technologies. The present technology opens the door to radically new music composition methods.

The present invention enables, in one aspect, a new method of music notation that uses Bezier paths (defined using the GUI) to define musical content based on tone, pitch, volume, effects and the duration thereof. These paths enable precise definition of complex musical variations. These variations can be modulated instantly by operation of the computer system of the present invention.

One difference between the computer system of the present invention and any prior art system is that the present invention uses the mathematical descriptions of Bezier paths to store and instantly play back any variation of a note's pitch, volume, effects and the duration thereof. This allows the computer system of the present invention to be complete, instantaneous, precise and flexible. Manipulation of a note's paths by a user effects a corresponding and immediate modulation of its assigned note qualities. An important aspect of music is thematic variation and progressions. These aspects are highly tunable by repetition and incremental modification of paths, creating previously inexpressible intricate thematic progressions in accordance with the present invention.

The computer system is adapted to enable a user to manipulate the pitch and/or volume and/or effects paths, as a group, as a single path, or a section of a path. The computer system supports one or more such manipulations by the user, for example a path or a section of a path or a group of paths or any combination of paths and sections of paths may be incrementally nudged, rotated, flipped, flopped, roughened, bloated, stretched, squeezed, twisted, zig-zagged, warped, and any combination of the foregoing. In addition, a skilled reader will appreciate any new instrument can be applied to a path or a section of a path based on a user selection.

As mentioned, one contribution of the present invention is the reading of Bezier paths as musical notes. The present invention also provides a series of rules that can govern the reading (and therefore playing) of Bezier paths and variations of Bezier paths.

These rules cover two methods: 1) The selection of paths and/or sections of paths to play and 2) how to read paths that overlap.

### Pitch Mapping

One aspect of the present invention, as previously mentioned is the use of a Model View Controller system that generates notes based on the algorithms of underlying curved model Bezier paths that describe the note's pitch and duration (for example see FIGS. 10 and 12).

Following the capture of the original drawing points from the present invention's

“View” components, all further displays of the data to the user through the software's “View” components, are in fact, actually representations of the underlying calculated Bezier model objects. The present invention uses the pitch grid views only as a frame of reference to determine basic pitch parameters of a Bezier path that is generated to the user's finger/stylus/electronic stylus drag across the GUI (FIG. 12). The Bezier path is a complex multi-node path of arbitrary node length and type, and is maintained in memory as such for future playback or modification.

It is this Bezier path (FIG. 12, A) that is interpreted and displayed on the GUI, not the original finger drag/stroke (though it may look exactly the same on the GUI). It is the use of this malleable underlying Bezier path that allows the displayed strokes to be modified into any pitch/volume/effect/duration description.

Since the Bezier path maintains its coherent identity through a mathematical relationship to a set of nodes it is possible to manipulate the path shape while having it maintain its general shape. The path can be smoothly and infinitely stretched, shrunk, deformed, copied or moved etc., while still maintaining pitch description that is accurate to its current modification, allowing for accurate data from any point on the curve to continue to be gathered, maintaining the fidelity of note quality (FIG. 13).

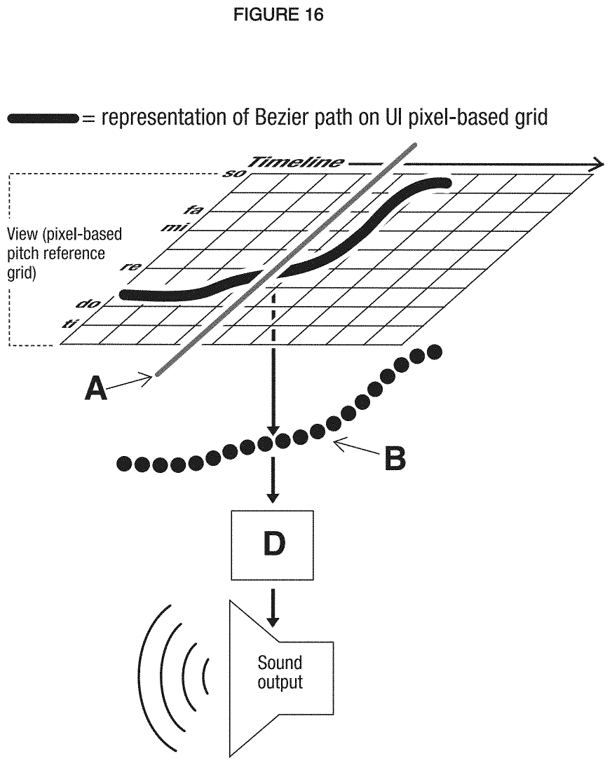

The computer system may present a conventional playhead (FIG. 16, A) (or UI component that shows the current progression of play of a musical content) that is modified based on the present invention to move across the grid's timeline and encounter the start of a Bezier path, the pitch/volume/effect played is generated by means of mathematical calculation of points along the paths (see calculation methods below). These calculations may be made on-the-fly, or may exist as a pre-calculated set of points to be referenced. The calculated pitch/volume/effect is then played by means of proprietary commands to an oscillator or a sampler, or translated into a standards-compliant audio control language such as MIDI (FIG. 16, D).

This results in being able to have smooth transitions between pitches: calculation points are mapped evenly along a path regardless of its horizontal orientation along the timeline (FIG. 16, B). If a pitch path slides steeply up to another note the consistent mapping along the path in effect increases the resolution while sliding up, ensuring a pleasing ‘un-stepped’ sound. This is especially important when emulating instruments such as the trombone or violin, in which pitches are often transitioned by means of smooth gradients or ‘slides’. It is important to note that these calculation points have no relationship to the pixels on the view pitch grid.

The calculation methods used may include but are not limited to those detailed below.

### Calculation Using Pitch Bend:

The present invention takes the path drawn onto the touch surface by the mouse, finger, stylus or electronic stylus and converts it into a multi-node Bezier path, that incorporates:
a) Note start time
b) Note length
c) Note pitch variations over time

The pitches along the Bezier path are calculated by discovery of a Y position on the path in relation to a given X value input—an example of the calculations in the case of a Cubic Bezier Node (the most common node type)—is given below:

Where t=an X position, given in percent, between the start and end node, of a cubic Bezier path segment.

t=(x−StartPoint.x)/(EndPoint.x−StartPoint.x);

F1(t)=t3

F2(t)=3t2(1−t)

F3(t)=3t(1−t)2

F4(t)=(1−t)3

These equations are then combined:

p.X=StartPointX*F1(t)+ControlPoint1X*F2(t)+ControlPoint2X*F3(t)+EndPointX*F4(t)

p.Y=StartPointY*F1(t)+ControlPoint1Y*F2(t)+ControlPoint2Y*F3(t)+EndPointY * F4(t)

### Where:

F1 are the Bezier functions, F1, F2, F3, F4 above
t is a percentage of the distance along the curve (between 0 and 1) which is sent to the Bezier functions F1, F2, F3, F4
p is the point in 2D space, we calculate for X and Y, and then combine to make the point

These calculations can take place on-the-fly, or can generate a pitch lookup table of arbitrary resolution.

Corresponding MIDI values (or those of another audio control language) are then generated, including:

a) Best choice of pitch center for degree of least modulation
b) MIDI ‘note on’ message at the correct point in timeline of the start of the path
c) MIDI ‘note off’ message at the correct point in timeline of the end of the path

Live playback of the path is affected by generating MIDI pitch bend data at points along the path to bend the pitch of the note to represent that of the path. MIDI data is calculated to the degree required to create a smooth tone to the human ear. The path can be modified or stretch in any fashion, and the MIDI data simply recalculated as required using the following formula:

Where:

f1=choice of pitch center of Bezier Path
f2=calculated pitch of specific point on path
c=difference in cents from pitch center to pitch of path point

c=1200×log 2(f2/f1)

This is then calculated against a neutral pitch bend value (the half way point in the total pitch range), in the case of MIDI, this neutral value is 8192:
cps=cents per pitch bend step
npv=neutral pitch bend value
pbv=final pitch bend value
c=calculated difference in cents between root pitch and current value on path

pbv=npv+(c×cps)

This final pitch modulation value is then applied to the pitch center to output the correct pitch for the given position on the Bezier path.

### Volume Mapping

The present invention uses a volume view grid that uses Bezier paths representing changes to volume along the timeline as part of the GUI (FIG. 7). Users drag a finger, stylus, electronic stylus or mouse across the grid to create the underlying curved model Bezier path that describes variation in note volume.

Bottom of the volume graph is zero volume, top of the graph is maximum and path Y position is simply a percentage of this. Path position on the Y axis for a given X position is calculated as above in the case of pitch, but instead of it being translated into pitch modulation information, this path Y position is translated into a percentage of overall volume. In the case of MIDI, a number is generated between a MIDI volume value of 0 and a maximum volume value of 127.

Such that:

final volume=max volume×(calculated Y position/max Y position)

These volumes can be calculated on-the-fly or pre-calculated to an arbitrary degree of precision for playback.

### Effect Mapping

The present invention uses an effect view grid that uses Bezier paths representing degree of application of an effect along the timeline as part of the GUI (FIG. ?). Users drag a finger, stylus or mouse across the grid to create the underlying curved model Bezier path that describes degree of application of an effect.

Bottom of the effect graph is zero effect, top of the graph is maximum and path Y position is simply a percentage of this. Path position on the Y axis for a given X position is calculated as above in the case of pitch, but instead of it being translated into pitch modulation information, this path Y position is translated into a percentage of application of overall effect. In the case of MIDI, a number is generated between a MIDI effect value of 0 and a maximum effect value of 127.

Such that:

final effect=max effect×(calculated Y position/max Y position)

These effects can be calculated on-the-fly or pre-calculated to an arbitrary degree of precision for playback.

### Notation Method

A skilled reader will appreciate that prior art music notation methods, including variations on classic notation, assume that the clef notes used are describing the pitch and duration of various musical instruments. Clef notes are rigid and one-dimensional and requires a complex array of notes to describe the many variations in pitch and duration (including the use or various rest notes).

One aspect of the invention is a new notation method, which differs in that it uses Bezier paths to describe pitch, allowing for the precise expression of any pitch and length, and does not assume to imitate a musical instrument's limitations in pitch expression or length of note (FIG. 6).

Prior art musical staff notation methods use imprecise verbal descriptions to describe volume e.g. ‘forte’ (loud) and ‘crescendo’ (increasing in volume). The new notation method of the present invention uses Bezier paths to precisely describe volume (FIG. 7), allowing for the expression of variations of volume and volume duration, and does not assume to imitate a musical instrument's natural volume limitations.

Prior art notation does not exist for the precise description of the application of an effect.

Prior art notation generally uses horizontal lines across the Y (vertical) axes to indicate pitch, but the horizontal lines are spatially inaccurate as they are equidistant whether there is a semitone or a whole tone between consecutive notes. Therefore prior art notation necessitates the use of complicated and confusing key signatures consisting of sharps and flats to denote whether the space between horizontal lines represents a whole or a half tone. In contrast based on the novel notation method of the present invention, the horizontal lines across the Y axis accurately represent the distance between each of the 12 half tones that make up the musical scale and therefore accurately displays note pitch frequency (FIG. 6). This allows the user's drawn path to easily and precisely express sliding changes in pitch frequency, whether the transition is a whole tone or a semitone or any fraction thereof.

FIGS. 6, 7, 8 provide a representative illustration of a possible graphical user interface for operating the computer system of the present invention. Specifically, the depicted interface enables the manipulation of a note through a pitch manipulation timeline grid, a volume manipulation timeline grid and effect manipulation timeline grid(s). The timeline of the grids are synced, so as to enable along their mutual timeline the manipulations required to accurately modify the note within the range of musical possibilities.

More specifically, FIGS. 6, 7, 8 show a notation system using three or more XY grids. The first grid is for notation of a note's pitch in which X (vertical) represents note duration in which timeline moves left to right, and Y (horizontal) represents note's pitch. The second grid aligns to the first grid along X axes. In the second grid, X represents note's duration in which timeline moves left to right, and Y represents note's volume range from silence to maximum volume. A third or more grids aligns to the first grid along X axes. In the third or more grids, X represents note's duration in which timeline moves left to right, and Y represents note's degree of application of an effect ranging from no effect to maximum application of the effect. Note duration, pitch, volume and effects axes can be oriented in any direction.

A skilled reader will appreciate that numerous variations of the various interfaces shown are possible. For example, the timeline can move right-to-left or bottom-to-top or top-to-bottom or any variation thereof. X axes can be added to grids to accommodate any length of composition and can represent any beat configuration (3/4, 6/15 etc.) and beat length in time. Y axes can be added to pitch grid to accommodate any number of octaves. Also a plurality of pitch, volume and effects grids assigned to multiple voices can by synced along their timelines to allow for the creation of complex orchestrations (for example).

A note's pitch, volume and effects are defined on the pitch, volume and effects grids by drawing descriptive Bezier paths. These paths defining pitch, volume and effects may be thin enough to be accurately placed on the grids, but can be any length or position on their respective grids, including but not restricted to: straight lines, curves or any variation thereof, and paths overlapping on the X axes. These linear descriptions are therefore capable of describing any imaginable configuration of a note's pitch, volume, duration and effects.

Users may assign ‘voices’ (e.g. electric guitar, violin) to pitch paths or sections of pitch paths. Each ‘voice’ can be shown on the display by different coloured paths or by variations on the stroke of the paths (for example a dotted path). Different voices can be overlaid on the same grid, or layered on separate but XY-aligned grids that the user toggles between. Users can input paths by drawing freehand (rougher), or freehand with automatic smoothing, or by draw options in which a drawn path ‘snaps’ to beat or pitch, or by placing anchor points connected by straight lines or curves.

### Path Modulation Methods

Music composition requires variations of a note or group of notes. The present invention enables variations of notes or group of notes by applying to their associated paths one or more of three methods: 1) Modification of a paths or group of paths, 2) Variations of the playing of paths or sections thereof by selecting specific grid areas, and 3) Variations of the rules governing the reading (playing) of paths.

### 1) Modification of a Paths or Group of Paths

All paths drawn (straight or curved) can be Bezier paths with anchor points. Anchor points, section(s) of path(s) between anchor points and whole paths can be selected. Anchor points can be changed from a rounded to corner point. Anchor points can also be added anywhere along an existing path to enable further modification.

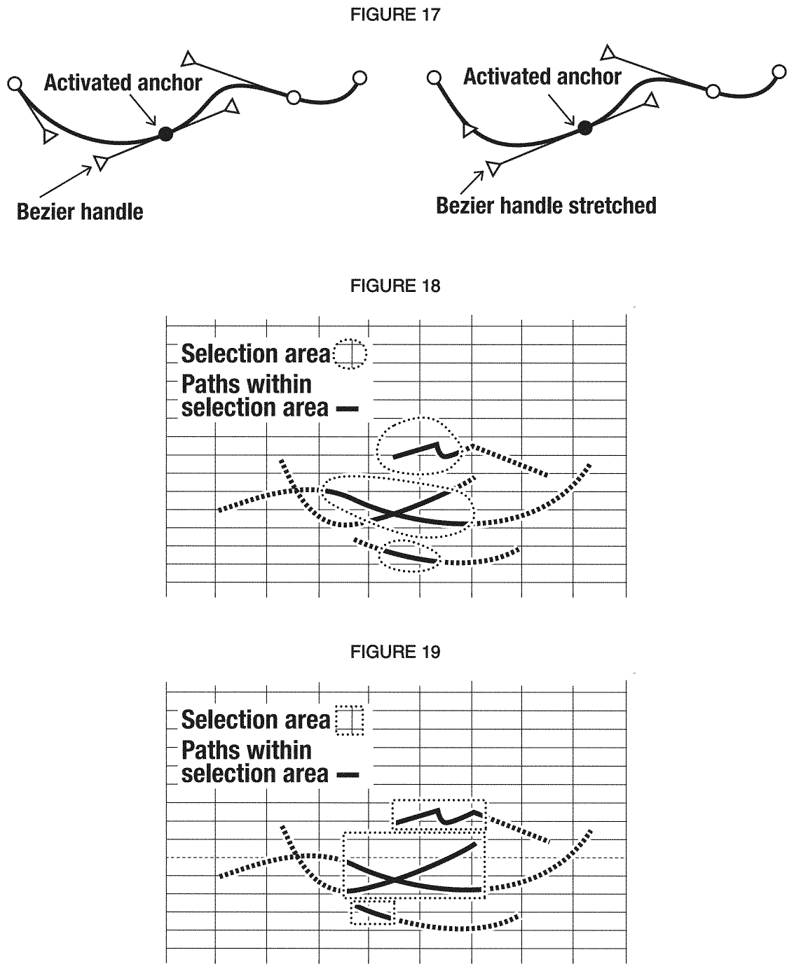

An individual anchor point on a curved path or end of a curved path can be selected to show its Bezier handles. A section of a path between two anchor points can also be selected to show the Bezier handles related to that section of path. These handles can be moved to change the curve of an individual path, for example as shown in FIG. 17.

Whole paths and/or sections of paths can also be selected individually either sequentially or discontinuously, or by selecting a specific grid area(s), then modified by methods including but not restricted to:

Path Modification Sub-method 1: Paths and/or section(s) of paths can be deleted.

Path Modification Sub-method 2: Paths and/or section(s) of pitch paths can be copied and pasted within its pitch grid or into a new pitch grid. A user can paste selection as an addition on top of existing paths, or paste to an empty area of a pitch grid, or any fractional overlap thereof.

Path Modification Sub-method 3: Paths and/or section(s) of volume paths can be copied and pasted within its volume grid or into a new volume grid. A user can paste selection as an addition on top of existing paths, or paste to an empty area of a volume grid, or any fractional overlap thereof.

Path Modification Sub-method 4: Paths and/or section(s) of pitch paths can be copied and pasted into its related volume grid or into an unrelated volume grid. A user can paste selection as an addition on top of existing volume paths, or paste to an empty area of a volume grid, or any fractional overlap thereof.

Path Modification Sub-method 5: Paths and/or section(s) of volume paths can be copied and pasted into its related pitch grid or into an unrelated pitch grid. A user can paste selection as an addition on top of existing pitch paths, or paste to an empty area of a pitch grid, or any fractional overlap thereof.

Path Modification Sub-method 6: A whole path can be stretched and squeezed both horizontally or vertically.

Path Modification Sub-method 7: A whole path can be selected and moved intact and incrementally within its grid.

Path Modification Sub-method 8: Paths and/or section(s) paths can be incrementally rotated.

Path Modification Sub-method 9: Paths and/or section(s) of paths can be flipped both horizontally and vertically.

Path Modification Sub-method 10: Paths and/or section(s) paths can be incrementally scaled up and down in size.

Paths and/or section(s) of paths can also be modified by path filters and/or their incremental applications. These filters include but are not restricted to: free distort, pucker & bloat, twist, zigzag, roughen, warp variations, duplication using offset variations, inclusion/exclusion of paths contained within paths, and variable-stepped blending between two selected paths.

### 2) Variations of the Playing of Paths or Sections Thereof by Selecting Specific Grid Areas.

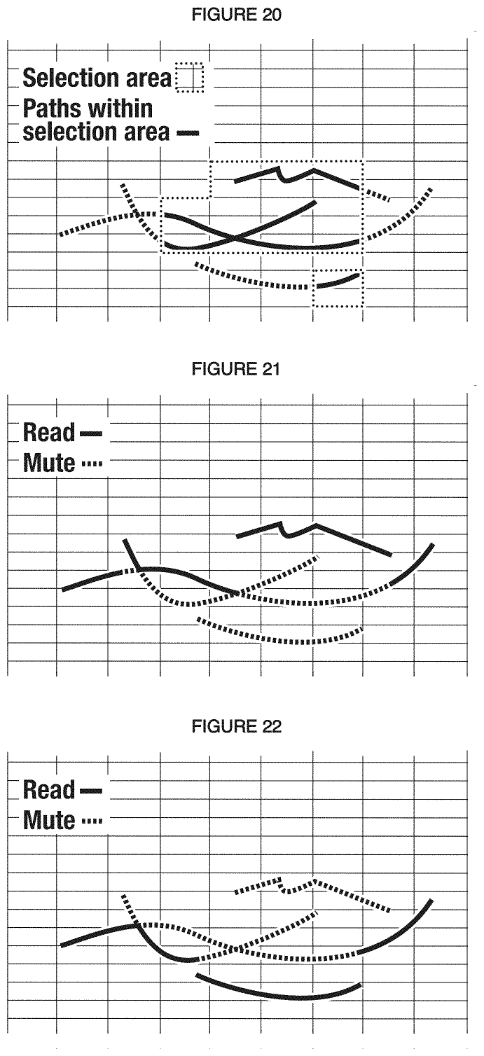

A user selects a specific area(s) of pitch and/or volume grids to be played. Selected area(s) can be any shape (FIG. 18). This area(s) may contain whole paths and/or sections of paths. The user can be presented with the option of making selections constrained for example to a rectangular area(s) (FIG. 19) or to rectangular area(s) that snaps to beat and/or pitch axes in the pitch grid, or to beat and/or volume axes in the volume grid, or to beat and effect axes on the effects grid (FIG. 20).

Selected area(s) in pitch and/or volume grid and/or effects grids, including all paths and sections of paths contained therein, can be played applying any of the read rules that follow.

### 3) Variations of the Rules Governing the Reading (Playing) of Paths on Pitch, Volume and Effects Grids.

Reading/playing of notation may move left to right. When just one path is encountered on the X axis of a grid, the one path is read. When additional paths are encountered i.e. when paths overlap X axes, they trigger the application of read rules that include but are not restricted to the implementations described after this.

FIGS. 21-37 help understand possible implementations of the music generator/controller/modifier of the present invention, and the different system-user workflows that are associated with operation of the computer system of the present invention. More specifically FIGS. 21-37 illustrate particular rules for operating the computer system of the present invention.

Rule 1) Read Highest Path. As a timeline moves left to right and encounters an overlap, the path highest on the Y axis takes precedence and is read. Lower path(s) are muted (FIG. 21). If different voices (e.g. electric guitar, violin) have been assigned to different pitch paths within a grid, the voice assigned to the highest pitch path is read.

Rule 2) Read Lowest Path. As a timeline moves left to right and encounters an overlap, the path lowest on the Y axis takes precedence and is read. Higher path(s) are muted (FIG. 22).

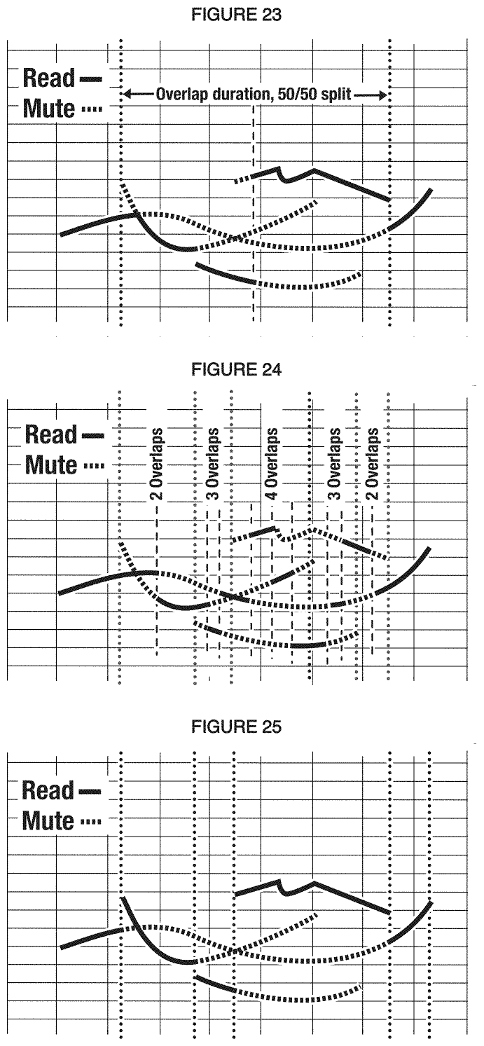

Rule 3) Shared Read Of Highest And Lowest Paths. Length of overlap of two paths can be calculated and read time can be shared between two paths for duration of their overlap (FIG. 23). Split can be 50/50, 73/27 or any fraction of overlap duration.

Rule 4) Shared Read Of All Overlapping Paths. Length of overlap of paths can be calculated and read time can be divided between the paths for the duration of their overlap. Where two paths overlap the read duration of the overlap can be split in two lengths distributed between the duration of the overlap. Where three paths overlap the read duration can be split into three lengths distributed between the duration of the overlap, and so on (FIG. 24).

Rule 5) Read Newest Path As It Appears On The Timeline. As timeline moves left to right and encounters a new path, the new path can be read and all other paths are muted. New path can be read regardless of whether it's the highest or lowest path. Once a new path starts to be read all other paths are muted (FIG. 25).

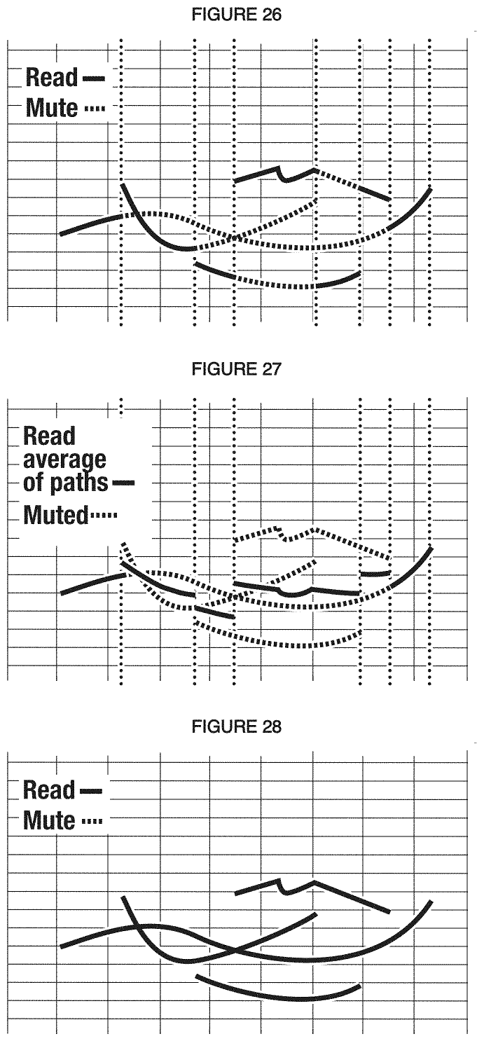

Rule 6) Read Alternating Paths As Defined By End/Beginning Of Any Overlapping Path Met In Timeline. As a timeline moves left to right, the beginning or end of overlap paths are used as markers to divide X axes into discrete sections. These discrete sections are read in an alternating order (FIG. 26).

Rule 7) Read Average Of Highest And Lowest Paths. Average of all overlap paths can be calculated and read (FIG. 27).

Rule 8) Read All Paths. As timeline moves left to right, all paths encountered are read (FIG. 28).

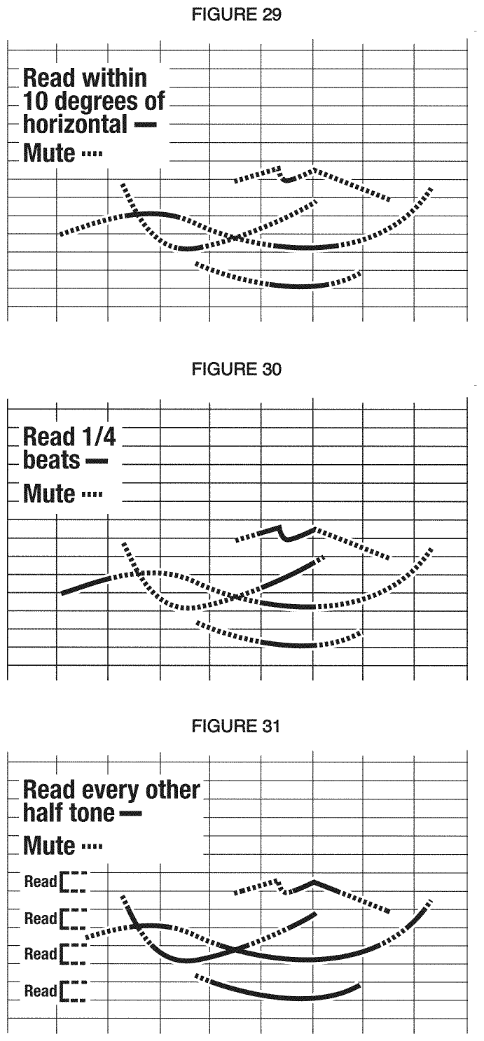

Rule 9) Only Read Paths That Fall Within A Specified Angle. As timeline moves left to right, in one aspect only paths are read that fall within a defined angle (FIG. 29). For example this read rule could be set to ignore curves that get too vertical.

Rule 10) Only Read Paths That Fall Within A Specified Beat/Time Period. As timeline moves left to right, in one aspect only paths are read that fall within a specified beat (FIG. 30). For example this read rule could be set to play only paths that fall within every first 1/4 note of 4/4 time, or any time/beat variation or combinations thereof.

Rule 11) Only Read Paths That Fall Within A Specified Pitch Frequency. As timeline moves left to right, in one aspect only paths within a specified pitch range are read (FIG. 31). For example this read rule could be set to only play paths that fall within 1/8 tone above or below standard scale frequency, or to play only paths that fall within any specified pitch range or combinations thereof.

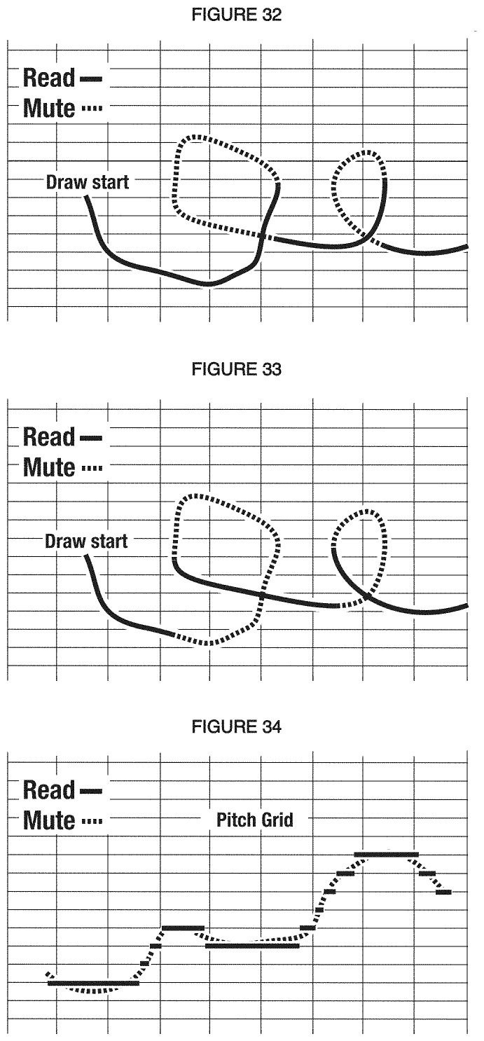

Rule 12) Only Read Paths Or Section Of Paths That Are Furthest As Drawn On the Timeline. As user draws paths back-and-forth on timeline, in one aspect only paths or sections of paths that are furthest on the timeline are played (FIG. 32). Any paths drawn on grid timeline after the furthest paths or sections of paths are muted.

Rule 13) Only Read Paths or Section of Paths That Are Most Recent As Drawn On the Timeline. As user draws paths back-and-forth on the timeline only the most recently drawn path will be played if new path or sections thereof overlap a pre-existing path (FIG. 33).

Rule 14) Read Nearest Whole Or Halftone. As user draws path on pitch grid the nearest whole or halftone can be played (FIG. 34).

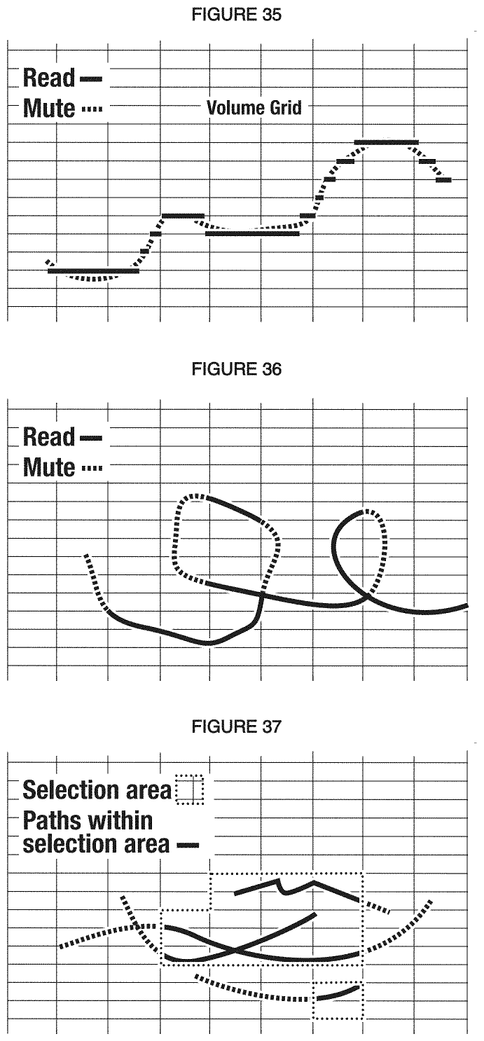

Rule 15) Read Nearest Volume Increment. As user draws path on volume grid, volume level nearest to path (as indicated by discrete volume increments on interface) can be played (FIG. 35).

Rule 16) Read Path(s) Clipped To Nearest Beat. As user draws paths back-and-forth on timeline, path can be clipped to most recent beat passed (FIG. 36).

Rule 17) Read Only Paths Or Sections Of Paths As Selected By User (FIG. 37). Refer to path/path sections selection methods described previously in 1) Modification of paths.

A skilled reader will understand that the computer program of the present invention can be similar to a Bezier path-based computer drawing program, but for music.

### Possible Implementations

The present invention, in one aspect thereof, may be implemented as a computer program. The computer program may be implemented as a tablet application, or mobile application or desktop application. Each of these may connect to the Internet to access computer network implemented resources through a server computer. For example the server computer may be used to access source files from an online library, store musical content to a cloud database, or to access collaborative features.

The system of the present invention may be implemented based on various centralized or decentralized architectures. The Internet or any other private or public network (for example a company's intranet) may be used as the network to communicate between the centralized servers and the various computing devices and distributed systems that interact with it.

The present invention may also be operable over a wireless infrastructure. Present wireless devices are often provided with web browsing capabilities, whether through WAP or traditional means.

As skilled reader will appreciate that numerous different implementations of the technology are possible.

The sound engine (10), (FIGS. 14, 15), may also be implemented in a collaborative fashion so as to enable two or more users to compose music together using collaborative music mapping GUIs.

In order to access to the sound engine (10), the operator of the web platform including the sound engine (10) may require users to subscribe to the platform. Various models may be used to monetize the platform including for example subscription fees, freemium models, or placement of advertising in web pages associated with the web platform.

It should be understood that the functionality described may be integrated with a range of different musical composition tools, whether by incorporating the computer program of the present invention into third party musical composition packages, or implementing the functionality described as a web service that is linked to third party musical composition platforms or services. The present invention is not limited to any particular implementation of, or use of, the technology described.

For example GarageBand™ may be enhanced by integrating the present invention as an additional mechanism for creating musical content. For example the system of the present invention may act as an input device to a variety of applications using a plugin, including GarageBand, but also Ableton Live, or Reason.

It should be understood that the functionality described may also be integrated using a mouse or tablet accessory (e.g. Wacom™) to input onto a non-touch-based display.

The present invention may also be implemented as a new sound source (sequencer) and thereby can work with and complement existing functionality, in effect adding a major new feature to various music related applications, including the ability to connect to and drive the sound engines of other music creation software thus also enhancing user experience.

Indeed, the present invention may replace the current musical composition tools in a variety of platforms with a new, more flexible and easier to use functionality based on the present invention.

In addition, a studio application may incorporate the sound engine (10) of the present invention, for example to provide dynamic input/editing tools as part of the studio application.

Additionally, music DJ application such as Cross DJ™ may incorporate one or utilities or features based on the present invention. The ease of use and new sound palette provided by the present invention fits well with the experimental nature of DJ-ing.

Video gaming systems may include the sound engine (10) or link to a web platform incorporating the sound engine (10), for example enabling users to customize sounds for playing environments.

The sound engine of the present invention may be integrated with a learning utility (not shown). There is a growing body of scientific evidence that learning music significantly enhances the student's overall ability to learn. The system provides, in one aspect, of an easy-to-use, intuitive notation system that enables dynamic feedback and experimentation that facilitates the learning and appreciation of music. With the present invention there is no need to learn an instrument or conventional music notation, rather a user can begin to make music by drawing paths on the music composition interfaces. The student, using the computer program of the present invention, can create musical arrangements that are pleasing, and thereby learn basic compositional and harmonic concepts.

### Advantages

Between the use of Bezier paths and the simplified music notation/interface the present invention embodies a distillation of music creation down to its essence, to a new medium. The methods of the present invention create an environment where music creation is a surprising combination of ease-of-use with unlimited expressiveness.

Numerous of the advantages of the invention have already been highlighted. Further advantages include:

The computer program of the present invention is easy to learn. The interface is very intuitive and simple because the grids visually and accurately represent pitch, volume, duration and applied effects. This negates the need to learn the complex classical notation system that employs the use of sharps and flats to denote pitch and note duration, verbal descriptions that imply volume dynamics. It also negates the need to learn the complex workings of pre-existing music creation programs with their imprecise linear representations that imply pitch, volume dynamics, and the complex and diverse rough visual representations that imply degrees of an applied effect.

The present invention provides a strong dynamic experience.

For music composers, the invention provides the ability to work anywhere using a laptop or tablet and sketch out musical ideas as they occur.

The invention provides the ability to easily imitate the fluidity and dynamics of a range of different conventional instruments, and in effect provides a mobile orchestra (for laptops and tablets) at a musician's fingertips.

The invention provides precise control over notes. It provides a palette with an infinite range of pitch/volume/duration/effects possibilities. The interfaces of the present invention provide precise control over notes, and the ability to create, modify and generate previously inexpressible pitch, volume and effects combinations, allowing for the exploration of new sounds.

There are cost advantages to the present invention as there is no need to hire musicians to input notes.

The invention provides precise communication between composers and musicians as composers can actually let musicians hear exactly how they want the pitch/volume/duration/effects of their notes played.

The invention provides a tool for learning an instrument. A person learning the sax, for example, could use the invention to explore new combinations of sax pitch, volume and effects, thereby raising the ‘bar’ for their skill level and improving their dexterity on the instrument.

In gaming systems the present invention provides the ability to easily integrate user customization of sound elements of games.

The present invention provides an engaging experience for music lovers, giving them the ability to participate in music composition with little initial knowledge being required.

The present invention provides a strong platform for music-based therapy. Its ease of use allowed allows children to doodle tunes to express their feelings. The technology described provides an innovative way to engage, for example, children on the non-verbal end of the autism spectrum.

The present invention makes it easy for users to sync and manipulate music files, creating derivative works. This would enable a new intimacy of collaborative creation by multiple composers.

### Further Implementations

It will be appreciated by those skilled in the art that other variations of the embodiments described herein may also be practiced without departing from the scope of the invention. Other modifications are therefore possible. It should be understood that the present invention may be implemented in a number of different ways, using different collaborative technologies, data frameworks, mobile technologies, web presentment technologies, content enhancement tools, document summarization tools, translation techniques and technologies, semantic tools, data modeling tools, communication technologies, web technologies, and so on. The present technology could also be integrated into one or more of such third party technologies, or such third party technologies could be modified to include the functionality described in this invention.

Several embodiments are specifically illustrated and/or described herein. However, it will be appreciated that modifications and variations are covered by the above teachings and within the scope of the appended claims without departing from the spirit and intended scope thereof. Various embodiments of the invention include logic stored on computer readable media, the logic configured to perform methods of the invention.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system for generating, controlling or modifying sound entities, comprising:
one or more computer processors configures to provide a sound processing utility for generating, controlling or modifying sound entities, the sound processing utility linked to one or more computers, or accessible by the one or more computers, of one or more graphical user interfaces for music composition or modification that enable a graphical map of one or more musical elements as parametric representations thereof, wherein the parametric representations are encoded with information elements corresponding to the musical elements, wherein the parametric representations and the encoded information elements can both be defined or modified by the graphical user interface so as to enable the generation, control, or modification of the sound entities, the musical elements comprising pitch, volume, duration and applied effects of notes, and the parametric representations defined using Bezier paths.

2. The system of claim 1, wherein the parametric representations comprise parametric curves and that define a path of curves.

3. The system of claim 1, further comprising one or more audio processing components operable to play the sound entities.

4. The system of claim 3, wherein the parametric representations encapsulate information for displaying a path on the interface, and also encapsulate the information for playing the sound entities, and wherein the parametric representations are modifiable based on user input to the interface such that modifications to the parametric representations make corresponding changes to the information for playing the sound entities.

5. The system of claim 1, wherein the parametric representations are generated using one or more processes that create scalable parametric paths, such that the encoding of the parametric representations with the information elements is scalable.

6. The system of claim 1, wherein the sound processing utility creates calculation points for a parametric representation corresponding to the musical elements into a Bezier path, stores the path, and if input is received from the interface to modify the parametric representation, more calculation points are added to the Bezier path corresponding to such input, thereby enabling the modification of the sound entities such that smooth transitions are audible when the sound entities are played using and audio processing component.

7. The system of claim 1, wherein the graphical user interface provides a music composition tool.

8. The system of claim 7, wherein the interface includes one or more grids, each grid including an timeline, and receiving input at the interface to create parametric representations and placing them in the timeline so as to construct a musical composition.

9. The system of claim 8, the one or more grids include a pitch grid, wherein the pitch grid is executable to allow one or more users to draw on the grid one or more paths corresponding to a note and any pitch between any notes so as to create a spatial representation of pitch attributes of sound elements that correspond to an associated pitch frequency spectrum.

10. The system of claim 9, wherein the length of the path on the grid timeline defines the duration of the note.

11. The system of claim 9, wherein the one or more grids further include a volume manipulation grid that is synchronized with the pitch grid such that input to the pitch grid and volume grid in aggregate enables modification of the musical elements.

12. The system of claim 9, wherein the one or more grids further include one or more effects grid for the application of audio filter effects that is synchronized with the pitch grid and volume grid such that input to the pitch grid, volume grid and effects grid(s) in aggregate enables modification of the musical elements.

13. A computer implemented method for generating, controlling, or modifying sound entities comprising:
displaying one or more music composition/modification graphical user interfaces implemented to one or more computers including or being linked to a touch screen display:
receiving one or more selections relevant to one or more musical elements using the interface, the musical elements comprising pitch, volume, effects and duration of notes:
generating one or more parametric paths corresponding to the selections and encoding the musical elements, the parametric paths defined using Bezier paths: and
storing the parametric paths so as to define one or more executable sound entities, wherein the sound entities can be defined or modified using the graphical user interface so as to enable the generation, control, or modifications of the sound entities.

14. A computer implemented method for generating, controlling, or modifying sound entities comprising:
displaying one or more music composition/modification graphical user interfaces implemented to one or more computers including or being linked to a touch screen display, wherein the interface includes one or more grids, a first grid for selecting pitch attributes, a second grid for selecting volume attributes, and a third or more grids for selecting effects attributes:
receiving one or more selections relevant to one or more musical elements using the interface:
generating one or more parametric paths corresponding to the selections and encoding the musical elements, and:
storing the parametric paths so as to define one or more executable sound entities, wherein the sound entities can be defined or modified using the graphical user interface so as to enable the generation, control, or modification of the sound entities:
accessing, including iteratively, the first grid, second grid, and third or more grids so as to define or modify pitch attributes, volume attributes, and effect attributes for the one or more sound entities:
receiving input using the graphical user interface that the definition or modification of the pitch attributes, the volume attributes, and the effects attributes have been completed, and:
storing the one or more sound entitles defined by the selection of the pitch attributes, volume attributes, and effects attributes to a data store, thereby providing one or more executable sound entities based on such pitch attributes, volume attributes, and effects attributes.

15. The method of claim 13, further comprising: playing the one or more sound entities, wherein the parametric paths encapsulate information for playing the sound entities.

16. The method of claim 13, further comprising displaying the parametric path on the interface, and wherein the parametric paths are modifiable based on input at the interface such that modifications to the parametric paths make corresponding changes to the information for playing the sound entities.

17. The method of claim 14, further comprising; playing the one or more sound entities, wherein the parametric paths encapsulate information for playing the sound entities.

18. The method of claim 14, further comprising displaying the parametric path on the interface, and wherein the parametric paths are modifiable based on input at the interface such that modifiable based on input at the interface such that modifications to the parametric paths make corresponding changes to the information for playing the sound entities.

19. The method of claim 13, wherein the interface includes one or more grids, each grid comprising a timeline, and the method further comprises receiving input at the interface to create the parametric paths and placing them in the timeline so as to construct a musical composition.

20. The method of claim 14, wherein each grid comprises a timeline, and the method further comprises receiving input at the interface to create the parametric paths and placing them in the timeline so as to construct a musical composition.

21. The method of claim 13, wherein the length of the parametric pitch path define the duration of the note.
